(19) United States
(12) Patent Application Publication
(10) Pub. No.: US 2023/0042053 A1
(43) Pub. Date: Feb. 9, 2023

(54) METHOD AND NETWORK NODE FOR CONTROLLING REPORT OF PRESENCE REPORTING AREA STATUS

(71) Applicant: Telefonaktiebolaget LM Ericsson (publ), Stockholm (SE)

(72) Inventors: Lei XIA, Shanghai (CN); Zhiwei QU, Shanghai (CN)

(21) Appl. No.: 17/788,796

(22) PCT Filed: Dec. 24, 2019
(86) PCT No.: PCT/CN2019/127991

§ 371 Date: Jun. 24, 2022

(51) Int. Cl. H04W 8/16

(52) U.S. Cl. CPC H04W 8/16

(57) ABSTRACT

The present disclosure provides a method in a network node for controlling report of a Presence Reporting Area (PRA) status. The method includes: receiving from another network node a message indicating a default PRA status; and refraining from reporting an initial PRA status of a terminal device to the other network node when the initial PRA status is consistent with the default PRA status.

### TECHNICAL FIELD

The present disclosure relates to communication technology, and more particularly, to a method and a network node for controlling report of a Presence Reporting Area (PRA) status.

### BACKGROUND

In the Long Term Evolution (LTE) or the 4th Generation (4G) wireless communication system, a PRA is an area defined by a Packet Data Network (PDN) Gateway (PGW) or a Mobility Management Entity (MME) based on Tracking Areas (TAs), cells and/or evolved NodeBs (eNBs) and can be used e.g., for the purpose of charging. For example, different charging policies can be applied to terminal devices, or User Equipments (UEs), located in different PRAs. A Policy and Charging Rules Function (PCRF) entity or a PGW can transmit an instruction to start PRA reporting for a UE to an MME. The instruction transmitted from the PGW to the MME (via a Serving Gateway (SGW)) can be carried in an Information Element (IE) “PRAAction” having a value of “start” and containing a PRA Identifier (ID) and optionally a PRA definition. Upon receiving the instruction, the MME can determine whether the UE is inside or outside the PRA based on a current location of the UE and the definition of the PRA, and report an initial PRA status of the UE with a flag “inside” or “outside” to the PGW and the PCRF entity. Afterwards, once the location of the UE changes, causing its PRA status to change from “inside” to “outside” or from “outside” to “inside”, the MME will report the updated PRA status of the UE to the PGW and the PCRF entity. For further details, reference can be made to the 3^{rd} Generation Partnership Project (3GPP) Technical Specification (TS) 29.274, V14.8.0, which is incorporated here by reference in its entirety.

Similarly, in the 5th Generation (5G) wireless communication system, a Policy Control Function (PCF) entity can transmit to a Session Management Function (SMF) entity a request for subscription to notifications about changes in a location of a UE with respect to an area of interest (e.g., a PRA). The definition of the PRA can be given in the request for subscription, including a PRA ID, and/or a list of TA IDs, cell IDs and/or (next) generation NodeB (gNB) IDs. In turn, the SMF entity can transmit to an Access and Mobility Management Function (AMF) entity a request for subscription to a “UE Mobility Event Notification” service for notifications about changes in the location of the UE with respect to the PRA (i.e., “in_area” or “out_of area”). Upon receiving the request for subscription, the AMF entity can determine whether the UE is inside or outside the PRA based on a current location of the UE and the definition of the PRA, and report an initial PRA status of the UE, i.e., “in_area” or “out_of_area”, to the SMF entity, which can in turn report the initial PRA status to the PCF entity. Afterwards, once the location of the UE changes, causing its PRA status to change from “in_area” to “out_of_area” or from “out_of area” to “in_area”, the AMF entity will report the updated PRA status of the UE to the SMF entity, which will in turn report the updated PRA status to the PCF entity. For further details, reference can be made to 3GPP TS 29.571, V15.3.0, which is incorporated here by reference in its entirety.

### SUMMARY

In practice, some PRAs may be very large and the corresponding PRA statuses for terminal devices may be “inside” at a high probability, while some other PRAs may be very small and the corresponding PRA statuses for terminal devices may be “outside” at a high probability. It is desired to reduce signaling overhead associated with reporting of initial PRA statuses of terminal devices, particularly in those cases where the terminal devices are much more likely to be in one PRA status than the other.

It is an object of the present disclosure to provide a method and a network node for controlling report of a PRA status, capable of reducing signaling overhead associated with reporting of an initial PRA status of a terminal device.

According to a first aspect of the present disclosure, a method in a network node for controlling report of PRA status is provided. The method includes: receiving from another network node a message indicating a default PRA status; and refraining from reporting an initial PRA status of a terminal device to the other network node when the initial PRA status is consistent with the default PRA status.

In an embodiment, the method may further include: reporting the initial PRA status to the other network node when the initial PRA status is different from the default PRA status.

In an embodiment, the network node may be an MME and the other network node may be an SGW.

In an embodiment, the message may be a Create Session Response and the default PRA status may be indicated in an IE, PRA Action.

In an embodiment, the network node may be an AMF entity, and the other network node may be an SMF entity.

In an embodiment, the message may be an Event Exposure Subscribe Request and the default PRA status may be indicated in Presence Information.

In an embodiment, the initial PRA status may be initially determined by the network node in response to receiving the message.

According to a second aspect of the present disclosure, a method in a network node for controlling report of a PRA status is provided. The method includes: transmitting a message indicating a default PRA status, to cause another network node to refrain from reporting an initial PRA status of a terminal device that is consistent with the default PRA status.

In an embodiment, the message may be to further cause the other network node to report an initial PRA status of the terminal device that is different from the default PRA status.

In an embodiment, the network node may be a PCRF entity, and the message may be a request for starting a PRA reporting event and may be transmitted to a PGW.

In an embodiment, the network node may be a PGW, the message may be a Create Session Response and may be transmitted to an SGW, and the default PRA status may be indicated in an IE, PRA Action.

In an embodiment, the other network node may be an MME.

In an embodiment, the network node may be a PCF entity, the message may be an Event Exposure Subscribe Request and may be transmitted to an SMF entity, and the default PRA status may be indicated in Presence Information.

In an embodiment, the other network node may be an AMF entity.

In an embodiment, the initial PRA status may be initially determined by the other network node in response to receiving the message.

According to a third aspect of the present disclosure, a network node is provided. The network node includes a communication interface, a processor and a memory. The memory contains instructions executable by the processor whereby the network node is operative to perform the method according to the above first or second aspect.

According to a fourth aspect of the present disclosure, a computer readable storage medium is provided. The computer readable storage medium has computer program instructions stored thereon. The computer program instructions, when executed by a processor in a network node, cause the network node to perform the method according to the above first or second aspect.

With the embodiments of the present disclosure, a default PRA status is introduced. The default PRA status can be signaled to an MME or an AMF entity. Accordingly, when an initial PRA status of a terminal device is consistent with the default PRA status, the MME or AMF entity can refrain from reporting the initial PRA status. In this way, the signaling overhead associated with reporting of initial PRA statuses of terminal devices can be reduced significantly, particularly in those cases where the terminal devices are much more likely to be in one PRA status than the other.

### BRIEF DESCRIPTION OF THE DRAWINGS

The above and other objects, features and advantages will be more apparent from the following description of embodiments with reference to the figures, in which:

FIG. 1 is a flowchart illustrating a method for controlling report of a PRA status according to an embodiment of the present disclosure;

FIG. 2 is a flowchart illustrating a method for controlling report of a PRA status according to another embodiment of the present disclosure;

FIG. 3 is a schematic diagram showing a signaling sequence of a process for reporting of a PRA status according to an embodiment of the present disclosure;

FIG. 4 is a schematic diagram showing a signaling sequence of a process for reporting of a PRA status according to another embodiment of the present disclosure;

FIG. 5 is a block diagram of a network node according to an embodiment of the present disclosure;

FIG. 6 is a block diagram of a network node according to another embodiment of the present disclosure; and

FIG. 7 is a block diagram of a network node according to yet another embodiment of the present disclosure.

### DETAILED DESCRIPTION

In the following description and claims, unless defined otherwise, all technical and scientific terms used herein have the same meaning as commonly understood by one of ordinary skills in the art to which this disclosure belongs.

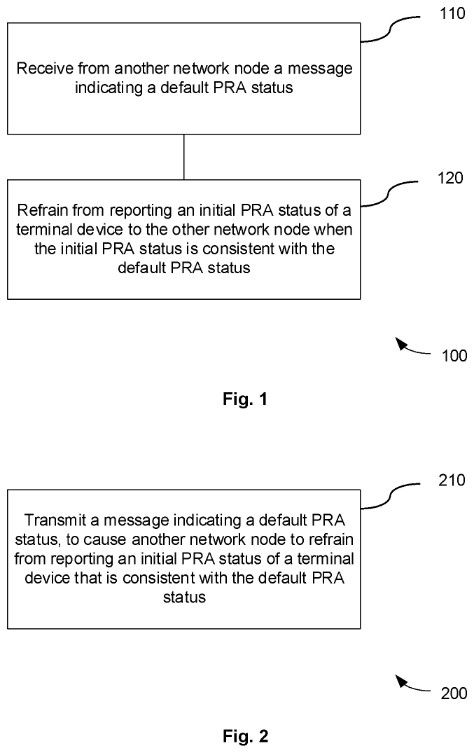

FIG. 1 is a flowchart illustrating a method 100 for controlling report of a PRA status according to an embodiment of the present disclosure. The method 100 can be performed at a network node, e.g., an MME or an AMF entity.

At block 110, the network node receives a message indicating a default PRA status from another network node. Here, the default PRA status can be either “inside” or “outside”, or either “in_area” or “out_of_area”.

At block 120, the network node refrains from reporting an initial PRA status of a terminal device to the other network node when the initial PRA status is consistent with the default PRA status. Here, the initial PRA status is initially determined by the network node in response to receiving the message. In other words, the initial PRA status is the PRA status the network node determines for the first time after receiving the message.

The network node can report the initial PRA status to the other network node when the initial PRA status is different from the default PRA status.

In an example, the network node can be an MME, and the other network node can be an SGW. In this case, the message can be a Create Session Response and the default PRA status can be indicated in an IE “PRAAction”.

For example, the IE “PRA Action” can be coded according to Table 1 below.

TABLE 1
PRAAction

| | Bits | | | | | | | |
|---|---|---|---|---|---|---|---|---|
| Octets | 8 | 7 | 6 | 5 | 4 | 3 | 2 | 1 |

| 1 | Type = 177 | | |
|---|---|---|---|
| 2 to 3 | Length = n | | |
| 4 | Spare | Instance | |
| 5 | Spare | INAP | Action |
| | | RA | |

| 6 to 8 | Presence Reporting Area Identifier | |
|---|---|---|
| 9 | Number of TAI | Number of RAI |

| 10 | Spare | Number of Macro eNodeB |
|---|---|---|
| 11 | Spare | Number of Home eNodeB |
| 12 | Spare | Number of ECGI |
| 13 | Spare | Number of SAI |
| 14 | Spare | Number of CGI |
| 15 to k | TAIs [1 . . . 15] | |
| (k + 1) to m | Macro eNB IDs [1 . . . 63] | |
| (m + 1) to p | Home eNB IDs [1 . . . 63] | |
| (p + 1) to q | ECGIs [1 . . . 63] | |
| (q + 1) to r | RAIs [1 . . . 15] | |
| (r + 1) to s | SAIs [1 . . . 63] | |
| (s + 1) to t | CGIs [1 . . . 63] | |
| t + 1 | Spare | Number of Extended Macro eNodeB |

| (t + 2) to v | Extended Macro eNB IDs [1 . . . 63] | | | |
|---|---|---|---|---|
| v + 1 | Spare | D | IN | OUT |

| | |
|---|---|
| u to (n + 4) | These octet(s) is/are present only if explicitly specified |

As shown in Table 1, Bit 3 in Octet v+1 (labeled as “D”) indicates whether the network node is to refrain from reporting an initial PRA status consistent with the default PRA status. For example, when Bit 3 is set to 1, it indicates that the network node is to refrain from reporting the initial PRA status consistent with the default PRA status; or when Bit 3 is set to 0, it indicates that the network node is to report the initial PRA status regardless of the default PRA status. Bit 2 in Octet v+1 (labeled as “IN”), when set to 1, indicates that the default PRA status is “inside”. Bit 1 in Octet v+1 (labeled as “OUT”), when set to 1, indicates that the default PRA status is “outside”. Bit 2 and Bit 1 cannot be set to 1 at the same time. For further details of Table 1, reference can be made to Section 8.108, “Presence Reporting Area Action”, in 3GPP TS 29.274.

Alternatively, the network node can be an AMF entity, and the other network node can be an SMF entity. In this case, the message can be an Event Exposure Subscribe Request and the default PRA status can be indicated in Presence Information (PresenceInfo). For example, the PresenceInfo as defined in Section 5.4.4.27 in 3GPP TS 29.571 can be modified to add a new attribute “Default PRA Status”, as shown in Table 2 below.

TABLE 2
Definition of type PresenceInfo

| Attribute name | Data type | P | Cardinality | Description |
|---|---|---|---|---|
| praId | String | C | 0 . . . 1 | Represents an identifier to the specified |
| | | | | area. This IE shall be present if the Area of |
| | | | | Interest subscribed or reported is a |
| | | | | Presence Reporting Area. |
| presenceState | PresenceState | C | 0 . . . 1 | Indicates whether the UE is inside or |
| | | | | outside of the area of interest (e.g presence |
| | | | | reporting area or the LADN area), or if the |
| | | | | presence reporting area is inactive in the |
| | | | | serving node. |
| trackingAreaList | array(Tai) | C | 1 . . . N | Represents the list of tracking areas that |
| | | | | constitutes the area. This IE shall be |
| | | | | present if the subscription or the event |
| | | | | report is fortracking UE presence in the |
| | | | | tracking areas. For non 3GPP access the |
| | | | | TAI shall be the N3GPP TAI. |
| ecgiList | array(Ecgi) | C | 1 . . . N | Represents the list of EUTRAN cell Ids that |
| | | | | constitutes the area. This IE shall be |
| | | | | present if the Area of Interest subscribed is |
| | | | | a list of EUTRAN cell Ids. |
| ncgiList | array(Ncgi) | C | 1 . . . N | Represents the list of NR cell Ids that |
| | | | | constitutes the area. This IE shall be |
| | | | | present if the Area of Interest subscribed is |
| | | | | a list of NR cell Ids. |
| globalRanNodeIdList | array(GlobalRan | C | 1 . . . N | Represents the list of NG RAN node |
| | NodeId) | | | identifiers that constitutes the area. This IE |
| | | | | shall be present if the Area of Interest |
| | | | | subscribed is a list of NG RAN node |
| | | | | identifiers. |
| Default PRA Status | PresenceState | C | 0 . . . 1 | Indicates which PRA status (in_area or |
| | | | | out_of_area) is a default PRA status for |
| | | | | which an initial PRA status report shall be |
| | | | | omitted |

The “Default PRA Status” can indicate “in_area” or “out_of_area” as a default PRA status and the network node is to refrain from reporting an initial PRA status consistent with the default PRA status. For further details of Table 2, reference can be made to Section 5.4.4.27, “Type: PresenceInfo”, in 3GPP TS 29.571.

FIG. 2 is a flowchart illustrating a method 200 for controlling report of a PRA status according to an embodiment of the present disclosure. The method 200 can be performed at a network node, e.g., a PCRF entity, a PGW, or a PCF entity.

At block 210, a message indicating a default PRA status is transmitted to cause another network node to refrain from reporting an initial PRA status of a terminal device that is consistent with the default PRA status.

In an example, the message may further cause the other network node to report an initial PRA status of the terminal device that is different from the default PRA status

Here, the default PRA status can be either “inside” or “outside”, or either “in_area” or “out_of_area”. The initial PRA status is initially determined by the other network node in response to receiving the message.

In an example, the network node can be a PCRF entity, and the other network node may be an MME. In this case, the message may be a request for starting a PRA reporting event transmitted to a PGW.

In another example, the network node can be a PGW, and the other network node may be an MME. In this case, the message may be a Create Session Response transmitted to an SGW, and the default PRA status may be indicated in an IE, “PRAAction”, e.g., according to Table 1 as described above.

In yet another example, the network node can be a PCF entity, and the other network node can be an AMF entity. In this case, the message may be an Event Exposure Subscribe Request transmitted to an SMF entity, and the default PRA status can be indicated in Presence Information (Presencelnfo), e.g., according to Table 2 as described above.

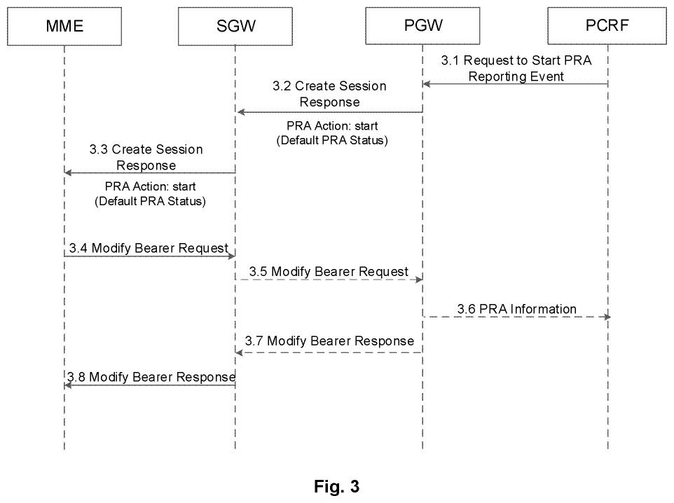

FIG. 3 is a schematic diagram showing a signaling sequence of a process for reporting of a PRA status according to the methods shown in FIGS. 1 and 2. This process can be used with e.g., an Attach or PDN connectivity procedure for a UE.

As shown, at 3.1, a PCRF entity sends a request for starting a PRA reporting event for a UE to a PGW, containing a default PRA status. In this example, the default PRA status is assumed to be “inside”, without loss of generality. It can be appreciated that the process also applies to the case where the default PRA status is “outside”. At 3.2, upon receiving the request, the PGW sends a Create Session Response to an SGW, containing an IE “PRAAction” with a value of “start” and indicating a default PRA status of “inside”. Referring to Table 1, the bits D, IN, and OUT can be set to 1, 1, and 0, respectively. At 3.3, the SGW forwards the Create Session Response to an MME. Upon receiving the Create Session Response from the SGW, the MME determines an initial PRA status of the UE based on a current location of the UE and a definition of the PRA.

When the initial PRA status of the UE is consistent with the default PRA status, i.e., when the initial PRA status is also “inside”, the MME will refrain from reporting the initial PRA status to the SGW. For example, the MME sends a Modify Bearer Request without an IE “PRA information” to the SGW at 3.4. Accordingly, the SGW sends a Modify Bearer Response to the MME at 3.8, without forwarding the Modify Bearer Request to the PGW, which in turn does not send any PRA information to the PCRF entity. In this case, the PGW and the PCRF entity may presume that the default PRA status of “inside” is valid, until they receive PRA information indicating “outside”. It is to be noted that only the report of the initial PRA status is omitted. If the PRA status of the UE changes afterwards, e.g., when the UE moves out of the PRA, the MME will send a notification of the updated PRA status to the SGW accordingly, and the SGW will forward the updated PRA status to the PGW, which in turn will forward the updated PRA status to the PCRF entity.

On the other hand, if the initial PRA status of the UE is different from the default PRA status, i.e., when the initial PRA status is “outside”, the MME sends a Modify Bearer Request containing an IE “PRA information” indicating “outside” to the SGW at 3.4, and then the SGW forwards the Modify Bearer Request to the PGW at 3.5. Accordingly, the PGW sends the PRA information indicating “outside” to the PCRF entity at 3.6. The PGW also sends a Modify Bearer Response to the SGW at 3.7, and then the SGW forwards the Modify Bearer Response to the MME at 3.8. If the PRA status of the UE changes afterwards, e.g., when the UE moves into the PRA, the MME will send a notification of the updated PRA status to the SGW accordingly, and the SGW will forward the updated PRA status to the PGW, which in turn will forward the updated PRA status to the PCRF entity.

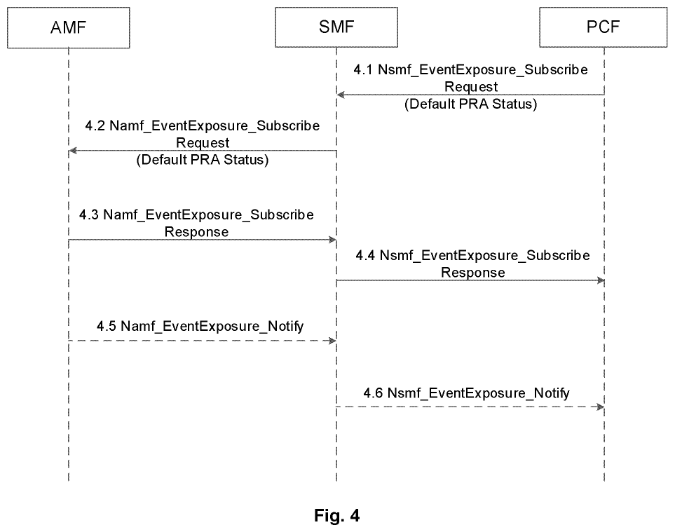

FIG. 4 is a schematic diagram showing a signaling sequence of a process for reporting of a PRA status according to the methods shown in FIGS. 1 and 2.

As shown, at 4.1, a PCF entity sends an Event Exposure Subscribe Request (Nsmf_EventExposure_Subscribe Request) to an SMF entity, requesting for subscription to notifications about changes in a location of a UE with respect to a PRA. The Request contains Presence Information (Presencelnfo) indicating a default PRA status, which can be carried e.g., in an attribute “Default PRA Status” in Table 2. In this example, the default PRA status is assumed to be “out_of_area”, without loss of generality. It can be appreciated that the process also applies to the case where the default PRA status is “in_area”. At 4.2, upon receiving the Request, the SMF entity sends an Event Exposure Subscribe Request (Namf_EventExposure_Subscribe Request) to an AMF entity, requesting for subscription to notifications about changes in the location of the UE with respect to the PRA. The Request also contains Presence Information (Presencelnfo) indicating the default PRA status of “out_of_area”, which can be carried e.g., in an attribute “Default PRA Status” in Table 2. The AMF entity sends an Event Exposure Subscribe Response (Namf_EventExposure_Subscribe Response) to the SMF entity, acknowledging a successful subscription, at 4.3. The SMF entity sends an Event Exposure Subscribe Response (Nsmf_EventExposure_Subscribe Response) to the PCF entity, acknowledging a successful subscription, at 4.4.

The AMF entity determines an initial PRA status of the UE based on a current location of the UE and a definition of the PRA. When the initial PRA status of the UE is consistent with the default PRA status, i.e., when the initial PRA status is also “out_of_area”, the AMF entity will refrain from reporting the initial PRA status to the SMF entity. For example, the AMF entity can send an Event Exposure Notify (Namf_EventExposure_Notify) without a Presence State of “out_of_area” to the SMF entity at 4.5. Accordingly, the SMF entity sends an Event Exposure Notify (Nsmf_EventExposure_Notify) without a Presence State of “out_of_area” to the PCF entity at 4.6. In another example, if the Event Exposure Notify at 4.5 or 4.6 is intended solely for reporting the initial PRA status, it can be simply omitted. That is, the AMF entity may not send an Event Exposure Notify for reporting the initial PRA status to the SMF entity and the SMF entity may not send an Event Exposure Notify for reporting the initial PRA status to the PCF entity. In this case, the SMF entity and the PCF entity may presume that the default PRA status of “out_of_area” is valid, until they receive PRA information indicating “in_area”. It is to be noted that only the report of the initial PRA status is omitted. If the PRA status of the UE changes afterwards, e.g., when the UE moves into the PRA, the AMF entity will send a notification of the updated PRA status to the SMF entity accordingly, and the SMF entity will forward the updated PRA status to the PCF entity.

On the other hand, if the initial PRA status of the UE is different from the default PRA status, i.e., when the initial PRA status is “in_area”, the AMF entity sends an Event Exposure Notify (Namf_EventExposure_Notify) with a Presence State of “in_area” to the SMF entity at 4.5. Accordingly, the SMF entity sends an Event Exposure Notify (Nsmf_EventExposure_Notify) with a Presence State of “in_area” to the PCF entity at 4.6. If the PRA status of the UE changes afterwards, e.g., when the UE moves out of the PRA, the AMF entity will send a notification of the updated PRA status to the SMF entity accordingly, and the SMF entity will forward the updated PRA status to the PCF entity.

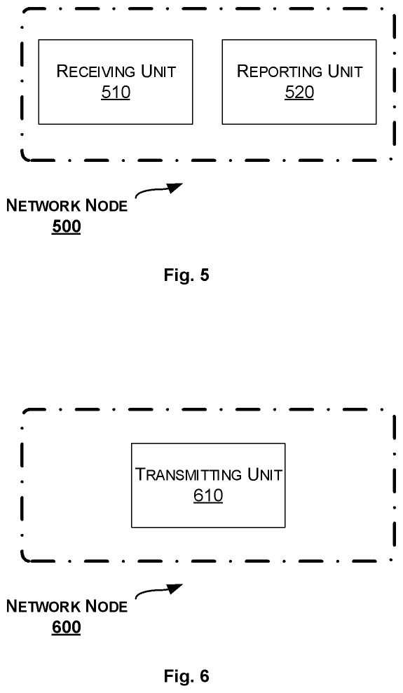

Correspondingly to the method 100 as described above, a network node is provided. FIG. 5 is a block diagram of a network node 500 according to an embodiment of the present disclosure.

As shown in FIG. 5, the network node 500 includes a receiving unit 510 configured to receive from another network node a message indicating a default PRA status.

The network node 500 further includes a reporting unit 520 configured to refrain from reporting an initial PRA status of a terminal device to the other network node when the initial PRA status is consistent with the default PRA status.

In an embodiment, the reporting unit 520 can be further configured to report the initial PRA status to the other network node when the initial PRA status is different from the default PRA status.

In an embodiment, the network node 500 may be an MME and the other network node may be an SGW. The message may be a Create Session Response and the default PRA status may be indicated in an IE, PRA Action.

In an embodiment, the network node 500 may be an AMF entity, and the other network node may be an SMF entity. The message may be an Event Exposure Subscribe Request and the default PRA status may be indicated in Presence Information.

In an embodiment, the initial PRA status may be initially determined by the network node in response to receiving the message.

The units 510-520 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 1.

Correspondingly to the method 200 as described above, a network node is provided. FIG. 6 is a block diagram of a network node 600 according to an embodiment of the present disclosure.

As shown in FIG. 6, the network node 600 includes a transmitting unit 610 configured to transmit a message indicating a default PRA status, to cause another network node to refrain from reporting an initial PRA status of a terminal device that is consistent with the default PRA status.

In an embodiment, the message may be to further cause the other network node to report an initial PRA status of the terminal device that is different from the default PRA status.

In an embodiment, the network node 600 may be a PCRF entity, and the message may be a request for starting a PRA reporting event and may be transmitted to a PGW.

In an embodiment, the network node 600 may be a PGW, the message may be a Create Session Response and may be transmitted to an SGW, and the default PRA status may be indicated in an IE, PRA Action.

In an embodiment, the other network node may be an MME.

In an embodiment, the network node 600 may be a PCF entity, the message may be an Event Exposure Subscribe Request and may be transmitted to an SMF entity, and the default PRA status may be indicated in Presence Information.

In an embodiment, the other network node may be an AMF entity.

In an embodiment, the initial PRA status may be initially determined by the other network node in response to receiving the message.

The unit 610 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 2.

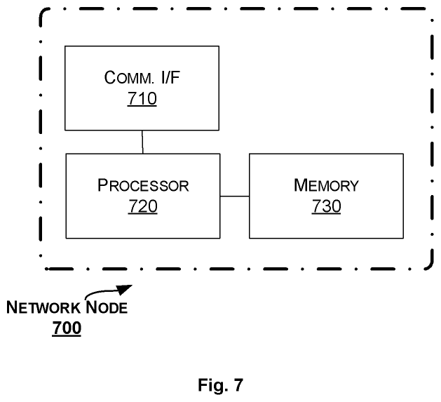

FIG. 7 is a block diagram of a network node 700 according to another embodiment of the present disclosure.

The network node 700 includes a communication interface 710, a processor 720 and a memory 730. For example, the memory 730 can contain instructions executable by the processor 720 whereby the network node 700 is operative to perform the actions, e.g., of the procedure described earlier in conjunction with FIG. 1. Particularly, the memory 730 can contain instructions executable by the processor 720 whereby the network node 700 is operative to: receive from another network node a message indicating a default PRA status; and refrain from reporting an initial PRA status of a terminal device to the other network node when the initial PRA status is consistent with the default PRA status.

In an embodiment, the memory 730 can further contain instructions executable by the processor 720 whereby the network node 700 is operative to: report the initial PRA status to the other network node when the initial PRA status is different from the default PRA status.

In an embodiment, the network node 700 may be an MME and the other network node may be an SGW. The message may be a Create Session Response and the default PRA status may be indicated in an IE, PRA Action.

In an embodiment, the network node 700 may be an AMF entity, and the other network node may be an SMF entity. In an embodiment, the message may be an Event Exposure Subscribe Request and the default PRA status may be indicated in Presence Information.

In an embodiment, the initial PRA status may be initially determined by the network node in response to receiving the message.

Alternatively, the memory 730 can contain instructions executable by the processor 720 whereby the network node 700 is operative to perform the actions, e.g., of the procedure described earlier in conjunction with FIG. 2. Particularly, the memory 730 can contain instructions executable by the processor 720 whereby the network node 700 is operative to: transmit a message indicating a default PRA status, to cause another network node to refrain from reporting an initial PRA status of a terminal device that is consistent with the default PRA status.

In an embodiment, the message may further cause the other network node to report an initial PRA status of the terminal device that is different from the default PRA status.

In an embodiment, the network node 700 may be a PCRF entity, and the message may be a request for starting a PRA reporting event and may be transmitted to a PGW.

In an embodiment, the network node 700 may be a PGW, the message may be a Create Session Response and may be transmitted to an SGW, and the default PRA status may be indicated in an IE, PRA Action.

In an embodiment, the other network node may be an MME.

In an embodiment, the network node 700 may be a PCF entity, the message may be an Event Exposure Subscribe Request and may be transmitted to an SMF entity, and the default PRA status may be indicated in Presence Information.

In an embodiment, the other network node may be an AMF entity.

In an embodiment, the initial PRA status may be initially determined by the other network node in response to receiving the message.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 720 causes the network node 700 to perform the actions, e.g., of the procedure described earlier in conjunction with FIG. 1 or 2.

The computer program product may be configured as a computer program code structured in computer program modules. The computer program modules could essentially perform the actions of the flow illustrated in FIG. 1 or 2.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random Access Memory (RAM), a Read-Only Memory (ROM), or an EEPROM, and the computer program modules described above could in alternative embodiments be distributed on different computer program products in the form of memories.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1. A method in a network node for controlling report of a Presence Reporting Area (PRA) status, comprising:
receiving from another network node a message indicating a default PRA status; and
refraining from reporting an initial PRA status of a terminal device to the other network node when the initial PRA status is consistent with the default PRA status.

2. The method of claim 1, further comprising:
reporting the initial PRA status to the other network node when the initial PRA status is different from the default PRA status.

3. The method of claim 1, wherein the network node is a Mobility Management Entity (MME) and the other network node is a Serving Gateway (SGW).

4. The method of claim 3, wherein the message is a Create Session Response and the default PRA status is indicated in an Information Element (IE) PRA Action.

5. The method of claim 1, wherein the network node is an Access and Mobility Management Function (AMF) entity, and the other network node is a Session Management Function (SMF) entity.

6. The method of claim 5, wherein the message is an Event Exposure Subscribe Request and the default PRA status is indicated in Presence Information.

7. The method of claim 1, wherein the initial PRA status is initially determined by the network node in response to receiving the message.

8. A method in a network node for controlling report of a Presence Reporting Area (PRA) status, comprising:
transmitting a message indicating a default PRA status, to cause another network node to refrain from reporting an initial PRA status of a terminal device that is consistent with the default PRA status.

9. The method of claim 8, wherein the message is to further cause the other network node to report an initial PRA status of the terminal device that is different from the default PRA status.

10. The method of claim 8, wherein the network node is a Policy and Charging Rules Function (PCRF) entity, and the message is a request for starting a PRA reporting event and is transmitted to a Packet Data Network Gateway (PGW).

11. The method of claim 8, wherein the network node is a Packet Data Network Gateway (PGW) the message is a Create Session Response and is transmitted to a Serving Gateway (SGW) and the default PRA status is indicated in an Information Element (IE) PRA Action.

12. The method of claim 10, the other network node is a Mobility Management Entity (MME).

13. The method of claim 8, wherein the network node is a Policy Control Function (PCF) entity, the message is an Event Exposure Subscribe Request and is transmitted to a Session Management Function (SMF) entity, and the default PRA status is indicated in Presence Information.

14. The method of claim 13, wherein the other network node is an Access and Mobility Management Function (AMF) entity.

15. The method of claim 8, wherein the initial PRA status is initially determined by the other network node in response to receiving the message.

16. A network node, comprising a communication interface, a processor and a memory, the memory comprising instructions executable by the processor whereby the network node is operative to perform the method according to claim 1.

17. A computer readable storage medium having computer program instructions stored thereon, the computer program instructions, when executed by a processor in a network node, causing the network node to perform the method according to claim 1.
